(19) United States
(12) Patent Application Publication
(10) Pub. No.: US 2021/0237953 A1
(43) Pub. Date: Aug. 5, 2021

(54) BIODEGRADABLE INSULATING STRUCTURES, ASSEMBLIES, AND ASSOCIATED METHODS

(71) Applicant: Lifoam Industries, LLC, Greer, SC (US)

(72) Inventors: Saumitra Bhargava, Clarksville, MD (US); Tim Pritchett, Fort Mill, SC (US); Walter Mercy, Felton, PA (US); Kevin Dolinar, Bel Air, MD (US); Scott Dyvig, Fishers, IN (US)

(21) Appl. No.: 17/169,166

(22) Filed: Feb. 5, 2021

Related U.S. Application Data
(60) Provisional application No. 62/970,428, filed on Feb. 5, 2020.

(51) Int. Cl. B65D 65/46; B29D 22/00

(52) U.S. Cl. CPC B65D 65/466; B29K 2067/046; B29D 22/003

(57) ABSTRACT

Biodegradable insulating structures and panel systems, and methods for producing and assembling the biodegradable insulating structures are provided. The biodegradable insulating structures include biodegradable foam panels formed from biobased polymer foam beads which include polylactic acid. The biodegradable foam panels have edges that form a seal with adjacent biodegradable foam panels to restrict thermal energy transfer at the edges.

### CROSS-REFERENCE TO RELATED APPLICATIONS

This application claims priority to U.S. Provisional Application No. 62/970,428, filed Feb. 5, 2020, which is incorporated herein by reference.

### FIELD OF THE DISCLOSURE

This disclosure relates generally to biodegradable foam insulation and to methods for producing lightweight, biodegradable foam insulated articles and, in particular, relates to biodegradable insulating structures formed from biobased polymer foam beads and methods for producing such biodegradable insulating structures.

### BACKGROUND

Insulated shippers are commonly used for shipping meal kits, confectionary products, cakes, other perishable goods, and medical items. Customers purchasing organic or premium foods often expect the insulated shipper to be biodegradable and compostable.

Prior attempts to provide biodegradable shippers with superior insulating properties utilize cellulose, shredded paper, cotton, denim, mineral wool batts, or extruded starch. While these materials may prove biodegradable, they must be loose or packed in film or paper to form insulated “envelopes” of material. Extruded starch results in irregular strands varying in thickness and suffering from brittleness. As a result, these materials suffer from poor thermal energy retention at the edges where the “envelopes” meet. Therefore, current distributors of perishable goods have to choose between biodegradability and insulating properties because biodegradable materials normally must be packed in these “envelopes” having poor thermal energy retention, while materials with superior thermal energy retention such as expandable polystyrene (EPS) are not biodegradable.

Molded or machined foam shippers, which exhibit improved insulating properties over loose or packed materials, are typically formed from expandable polystyrene (EPS). EPS is not biodegradable, however.

Thus, shippers formed from biodegradable materials with improved insulating properties would be beneficial.

### BRIEF DESCRIPTION OF THE DRAWINGS

The detailed description is set forth with reference to the accompanying drawings. The use of the same reference numerals may indicate similar to identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 is a perspective view of one embodiment of a biodegradable insulating structure in accordance with the present disclosure.

FIG. 2 is a perspective view of one embodiment of a partial biodegradable insulating structure in accordance with the present disclosure.

FIG. 3 is a perspective view of one embodiment of a biodegradable foam panel in accordance with the present disclosure.

FIG. 4 is a cross-sectional view of one embodiment of a seal formed by two adjacent biodegradable foam panels in accordance with the present disclosure.

FIG. 5A is a cross-sectional view of one embodiment of a seal formed by two adjacent biodegradable foam panels in accordance with the present disclosure.

FIG. 5B is a cross-sectional view of another embodiment of a seal formed by two adjacent biodegradable foam panels in accordance with the present disclosure.

FIG. 6 is a perspective, partially exploded view of one embodiment of a biodegradable insulating structure in accordance with the present disclosure.

FIG. 7 is a perspective, partially exploded view of one embodiment of a biodegradable insulating structure in accordance with the present disclosure.

FIG. 8 is a plan view of one embodiment of a biodegradable foam panel on which are affixed two biodegradable tapes in accordance with the present disclosure.

FIG. 9A is a perspective view of one embodiment of a 3-panel system with tape, in an initial flat configuration, in accordance with the present disclosure.

FIG. 9B is a perspective view of the embodiment of the 3-panel system shown in FIG. 9A after it has been folded into a C-shaped assembly in accordance with the present disclosure.

FIG. 9C is a perspective, partially exploded view of one embodiment of a biodegradable insulating structure, which may be formed from a pair of the C-shaped assemblies shown in FIGS. 9A-9B, in accordance with the present disclosure.

FIG. 10A is a perspective view of another embodiment of a biodegradable foam panel in accordance with the present disclosure.

FIG. 10B is a perspective view of another embodiment of a 3-panel system, formed from the biodegradable foam panel shown in FIG. 10A, in accordance with the present disclosure.

FIG. 11A is a perspective view of one embodiment of a 5-panel system, in an initial flat configuration, in accordance with the present disclosure.

FIG. 11B is a perspective view of the embodiment of the 5-panel system shown in FIG. 11A after it has been folded into a 5-panel box, in accordance with the present disclosure.

FIG. 11C is a perspective view of another embodiment of a biodegradable insulating structure, comprising the 5-panel box shown in FIG. 11B and a lid, in accordance with the present disclosure.

FIG. 12 is a perspective view of one embodiment of a 6-panel system in accordance with the present disclosure.

FIG. 13 is a partial, perspective view of one embodiment of the inside of a biodegradable insulating structure depicting structural elements for internal walls in accordance with the present disclosure.

FIG. 14A is a perspective view of another embodiment of a biodegradable insulating structure in accordance with the present disclosure.

FIG. 14B is a perspective view of another embodiment of a biodegradable insulating structure with supplemental biodegradable foam panels in accordance with the present disclosure.

FIG. 15A is a perspective view of one embodiment of a biodegradable foam panel having break-points in accordance with the present disclosure.

FIG. 15B is a perspective view of one embodiment of biodegradable foam panel fragments in accordance with the present disclosure.

FIG. 16 is a perspective view of one embodiment of a biodegradable insulating structure surrounded by an outer box in accordance with the present disclosure.

FIG. 17A is a perspective view of another embodiment of a biodegradable foam panel in accordance with the present disclosure.

FIG. 17B is a perspective view of still another embodiment of a biodegradable foam panel in accordance with the present disclosure.

FIG. 18 is a block flow diagram depicting one embodiment of a method for making a biodegradable insulating structure in accordance with the present disclosure.

FIG. 19 is a schematic view of one embodiment of a biodegradable tape applicator in accordance with the present disclosure.

FIG. 20 is a schematic view of another embodiment of a biodegradable tape applicator in accordance with the present disclosure.

FIG. 21 is a graph comparing thermal performance of conventional biodegradable insulating structures and an embodiment of biodegradable insulating structures in accordance with the present disclosure.

FIG. 22 is a graph of thermal performance for biodegradable insulating structures in accordance with the present disclosure.

### DETAILED DESCRIPTION

Biodegradable insulating structures and methods of making those structures are provided herein. The biodegradable insulating structures, and methods of making the biodegradable insulating structures, advantageously improve on the compostability and thermal insulating properties of conventional insulated structures, including but not limited to insulated shippers. The present disclosure includes non-limiting embodiments of biodegradable insulating structures. The embodiments are described in detail herein to enable one of ordinary skill in the art to practice the biodegradable insulating structures and associated methods of making, although it is to be understood that other embodiments may be utilized and that logical changes may be made without departing from the scope of the disclosure. Throughout the disclosure, depending on the context, singular and plural terminology may be used interchangeably.

Throughout this disclosure, various aspects are presented in a range format. It should be understood that the description in range format is merely for convenience and brevity and should not be construed as an inflexible limitation on the scope of the disclosure. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6, etc., as well as individual numbers within that range, for example, 1, 2, 3, 4, 5, and 6. This applies regardless of the breadth of the range.

The use of relational terms, such as, but not limited to, “top,” “bottom,” “left,” “right,” “front,” “back,” and the like are used in the written description for clarity in specific reference to the Figures, or to refer to the relative disposition of portions of the biodegradable insulating shipper, and are not intended to further limit the scope of the appended claims. For example, an element described as “right” or “left” does not necessarily require placement to an observer's right or left. Instead, such terminology is intended to illustrate the relative portions of the biodegradable insulating structure when used with corresponding other terminology. Any relative positioning in three-dimensional space of the elements of the biodegradable insulating structure is contemplated.

Flat panel shippers are containers formed out of a series of substantially flat panels that are formed or connected together to form a three-dimensional container. For example, a flat panel shipper may be a container blank, partial container blank, or other semi-formed container that may be formed into a three-dimensional container or structure. Such flat panels, before assembly, may be easily stacked, so that flat panel shippers may be preferred over pre-assembled or molded insulated boxes due to the beneficial ability to ship unassembled panels in a flat or semi-flat configuration.

Forming the flat panels out of foam may provide greater thermal properties by reducing or removing voids between pieces of insulation through which thermal energy can enter or escape. Biodegradable foam made out of compostable or biobased polymers may address environmental concerns associated with disposal of the materials once they are no longer useful for their intended purpose and minimize the use of petroleum. However, the polymers must meet certain physical and chemical characteristics in order for them to be suitable for the intended application. In expandable foams, the polymer composition must be able to be fabricated into a three dimensional shape that is lightweight and provides sufficient impact, sound, and thermal resistance or protection.

The terms “biodegradable” and “compostable” are used interchangeably herein to refer to materials that meet or exceed the relevant degradation standards in commercial composting facilities, such as the standards enumerated in ASTM D5338, ASTM D6400, and/or ISO 20200. For example, the biodegradable and compostable articles described herein degrade per the criteria set forth in ASTM D5338, ASTM D6400, and/or ISO 20200. That is, the biodegradable and compostable articles described herein degrade or be digested by microbes in a controlled compost study within 180 days, 90 days, or shorter. In certain embodiments, the biodegradable and compostable articles described herein are compostable in an industrial compost in about 42 days or shorter.

As used herein, the term “biobased” means materials that are synthesized from biological sources and refers to ingredients that reduce the use of non-renewable resources by integrating renewable ingredients as a replacement for at least a portion of the materials in a product. For example, replacement of petroleum used in making EPS with a renewable ingredient results in a biobased foam.

Biodegradable insulating structures have been produced from polylactic acid that can be fabricating using equipment similar to that used for expandable polystyrene. By producing biodegradable foam panels out of polylactic acid, it has been discovered that insulating structures can be assembled that are industrially compostable within 42 days, while improving on the thermal retention capabilities of conventional biodegradable shippers. In particular, it has been found that rigid, monolithic biodegradable foam panels can form a thermally effective seal with adjacent panels, preventing thermal energy loss at the edges.

These biodegradable insulating structures produced from polylactic acid may have a flex strength comparable to an expandable polystyrene structure of the same size and dimensions.

Biodegradable Insulating Structures

Biodegradable insulating structures are disclosed herein. In some embodiments, the biodegradable insulating structures include a plurality of biodegradable foam panels (e.g., two or more) having edges. Each of the biodegradable foam panels is formed out of biobased polymer foam beads including polylactic acid. In some embodiments, at least two of the plurality of biodegradable foam panels are disposed next to one another and interface along one of the edges of each of the at least two panels, the interfacing edges forming a seal to retain thermal energy, exclude thermal energy, prevent or reduce thermal energy transfer, or a combination thereof.

As used herein, a “panel” refers to a substantially planar, monolithic article, having a continuous composition throughout. In some embodiments, a single panel corresponds to a one side of a shipper, box, or other container. The panel could be any shape, such as a square, rectangle, or other polygon. The panel could have a thickness of from about 0.25 inches (6.4 mm) to about 4 inches (100 mm), for example about 0.25 inches (6.4 mm), about 0.375 inches (9.52 mm), about 0.5 inches (13 mm), about 0.75 inches (19 mm), or about 1 inch (25 mm). The thickness could be 1.25 inches (31.8 mm), 1.5 inches (38 mm), 2 inches (50 mm), 3 inches (80 mm), 4 inches (100 mm), or any thickness in between depending on the desired thermal and mechanical properties. The panel may have a side-length of from about 1 inch to about 48 inches or greater, for example about 1 inch (25 mm), about 2 inches (50 mm), about 6 inches (150 mm), about 12 inches (305 mm), about 24 inches (609 mm), about 36 inches (914.4 mm), about 48 inches (1220 mm), greater than 48 inches, or any side-length in between depending on the desired size, thermal properties, and mechanical properties of the insulating structure.

As used herein, the “thickness” of a panel refers to the depth of the panel measured from approximately the center of the panel. In other words, a panel having beveled edges is described as having the same “thickness” as a panel with rectilinear edges, although the depth of the panel changes at the edges by virtue of being beveled.

The panels may be used in isolation, where one panel constitutes the biodegradable insulating structure and is used to enhance the thermal properties of any container, box, shipper, or other structure. The panels may be used in plurality, where two or more panels constitute the biodegradable insulating structure and are used as a self-supporting container or to enhance the thermal properties of another container, box, shipper, or other structure. The panels that form the biodegradable insulating structure may each have the same thickness, or the panels may vary in thickness to provide, e.g., a thicker bottom panel to accommodate heavier contents, or one or more thicker side panels for improved insulating properties. Thus, any number of panels having any combination of thicknesses may form the biodegradable insulating structure and constitute a stand-alone container, box, or shipper. For example, a biodegradable insulating structure composed of six panels would form a standard 6-sided box and could be used without a housing or outer box.

As used herein, the term “insulating structure” means any structure capable of or contributing to the retention of thermal energy, exclusion of thermal energy, prevention or reduction of thermal energy transfer, or a combination thereof, including but not limited to an insulating shipper.

As used herein, the term “shipper” means a container for shipping articles. More specifically, an “insulated shipper” means a container having insulation for shipping thermally-sensitive articles, such as perishable food or medicine. For example, an insulated shipper may refer to an insulated shipper typically used for shipping meats, fish, meals, or ingredients for meals.

As used herein, the term “seal” means a juncture formed by two or more surfaces of one or more objects substantially coming into contact with each other in a manner that reduces or prevents the transfer of thermal energy through, around, or in connection with the seal.

In some embodiments, the biodegradable foam panels are rigid. As used herein, the term “rigid” means having an elastic modulus greater than 1 GPa. A rigid object therefore tends to break rather than deform. More specifically, a “rigid biodegradable foam panel” means a single, monolithic foam panel having an elastic modulus greater than 1 such that the panel breaks under sufficient stress rather than deforming. Note that a rigid object can have a high flex strength, which is the stress at failure in a bending test.

In some embodiments, the interfacing edges of the at least two biodegradable foam panels are beveled. As used herein, the term “beveled” means sloped or angled relative to a right-angle. More specifically, a “beveled edge” means an edge that is sloped or angled relative to an edge consisting of right-angles.

In some embodiments, the edges of the biodegradable foam panels include mechanical locking tabs and mechanical locking slots, wherein the tabs and the slots are configured to interlock to secure two or more biodegradable foam panels to one another. In some embodiments, the interfacing edges of at least two biodegradable foam panels have mechanical locking tabs and mechanical locking slots to facilitate a friction fit or compression fit interlock.

In some embodiments, the edges of the biodegradable foam panels include V-shaped grooves and V-shaped edges, wherein the grooves and edges are configured to interlock to secure two or more biodegradable foam panels to one another. In some embodiments, the interfacing edges of at least two biodegradable foam panels have V-shaped grooves and V-shaped edges to facilitate friction fit or compression fit interlock. The V-shaped groove and corresponding V-shaped edge have a geometry dictated by the thickness of the biodegradable foam panels that are interfacing. In other words, the V-shaped edge approximates the shape of a triangle with one side having a length equal to the thickness of the biodegradable foam panel, and a height that is less than the thickness of the adjacent, interfacing biodegradable foam panel. In some embodiments, this approximated triangle shape is an equilateral triangle, with all sides being equal and each angle being 60°. In other embodiments, this approximated triangle is an isosceles triangle, a right triangle, an acute triangle, an obtuse triangle, or any other suitable triangular shape. Therefore, in an embodiment in which two biodegradable foam panels each having a thickness of 1 inch (25.4 mm) interface using a V-shaped edge and a V-shaped groove, where the V-shape approximates an equilateral triangle, the V-shaped edge has a side length of 1 inch (25 mm) and 60° angles. In this embodiment, the V-shaped groove has equivalent corresponding geometry to facilitate interlock and a depth of ˜0.87 inches (˜22 mm).

In some embodiments, the edges of the biodegradable foam panels include rectilinear tongues and rectilinear grooves, wherein the tongues and grooves are configured to interlock and secure two or more biodegradable foam panels to one another. In some embodiments, the interfacing edges of at least two biodegradable foam panels have rectilinear tongues and rectilinear grooves to facilitate a friction fit or compression fit interlock. As used herein, the term “rectilinear” means consisting of only right angles.

In some embodiments, the biodegradable insulating structure includes at least one biodegradable tape on the surface of the biodegradable foam panels, such as to coat, cover, or connect the panels. In some embodiments, the biodegradable insulating structure includes a plurality of biodegradable tapes, which connect, cover, or coat the panels. In some embodiments, each of the biodegradable foam panels are connected to the other panels by the biodegradable tape. In other embodiments, one or more of the biodegradable foam panels are connected to one or more other panels by the biodegradable tape. For example, a bottom panel may be connected to adjacent side panels using one or more biodegradable tapes.

In some embodiments, the biodegradable insulating structure includes at least one biodegradable filament affixing together two or more of the plurality of biodegradable foam panels. In some embodiments, the biodegradable insulating structure includes a plurality of biodegradable filaments. In some embodiments, the biodegradable filament is positioned inside the biodegradable foam panels during the panel manufacturing process. In other embodiments, the biodegradable filament is positioned on the surface of the biodegradable foam panels and used in combination with biodegradable tape.

In some embodiments, in a disassembled state, each of the biodegradable foam panels is connectively separated from adjacent panels by a gap. For example, in a flat configuration of plurality of connected panels, adjacent panels may be spaced from one another yet connected by a biodegradable tape and/or a biodegradable filament. In particular, the gap may be of a selected size that permits each of the biodegradable foam panels to fold against adjacent panels to form the biodegradable insulating structure. The biodegradable tape may be of a discrete length, spanning only the distance necessary to connect the panels, or may be continuous, spanning the entire length of the panels and the spaces between them.

As used herein, the term “tape” means any strip of adhesive material suitable for connecting two or more items together. The adhesive material may include a backing layer and an adhesive coating layer. Non-limiting examples of tape include gummed kraft paper tape or gumback paper tape. As used herein, the term “filament” means a thin, flexible piece of material, usually taking the shape of a string or line.

In some embodiments, the biodegradable tape is printed with identifying marks, such as a brand indicator, label, package shipping/tracking, or other information. The identifying marks may be printed on the biodegradable tape immediately before or after applying the tape to the biodegradable foam panels, or the biodegradable tape may be manufactured with identifying marks.

In some embodiments, the biodegradable insulating structure includes a film on the surface of the biodegradable foam panels, such as to coat, cover, or connect the panels. In some embodiments, each of the biodegradable foam panels are connected to the other panels by the biodegradable film. In some embodiments, in a disassembled state, each of the biodegradable foam panels is connectively separated from adjacent panels by a gap. For example, the gap may be of a size that permits each of the biodegradable foam panels to fold against adjacent panels to form the biodegradable insulating structure.

As used herein, the term “film” means a thin, flexible piece of material, usually composed of a plastic, suitable for covering and/or encompassing an item.

Panel Systems for Forming Biodegradable Insulating Structures

Panel systems for forming biodegradable insulating structures are also disclosed herein. In some embodiments, a panel system for forming a biodegradable insulating structure includes a plurality of biodegradable foam panels formed of biobased polymer foam beads, where the biobased polymer includes polylactic acid. Each of the biodegradable foam panels may be connected to at least one other biodegradable foam panel by flexible connecting means. In some embodiments, the flexible connecting means includes a biodegradable film, tape, filament, or a combination thereof.

In some embodiments, the plurality of biodegradable foam panels that form the panel system are disposed in a flat configuration and are connectively separated by a gap that facilitates folding the system at the flexible connecting means. In some embodiments, when the system is folded at the flexible connecting means, edges of at least two of the plurality of biodegradable foam panels are configured to interface and form a seal at the interfacing edges. In some embodiments, the interfacing edges are beveled.

In some embodiments, the plurality of biodegradable foam panels that form the panel system include three biodegradable foam panels connected by the flexible connecting means to form a panel system that is configured to fold into a C-shaped assembly. In some embodiments, two of the C-shaped assemblies are configured to be connected together to form the biodegradable insulating structure.

In some embodiments, the plurality of biodegradable foam panels that form the panel system include five biodegradable foam panels connected by the flexible connecting means to form a panel system that is configured to fold into a 5-panel box. In some embodiments, the 5-panel box is configured to be connected to a biodegradable foam panel lid to form the biodegradable insulating structure.

In some embodiments, the plurality of biodegradable foam panels that form the panel system include six biodegradable foam panels connected by the flexible connecting means to form a panel system that is configured to fold into a 6-panel box. For example, when folded, the 6-panel box is a biodegradable insulating structure that may be used as a shipper, with or without the addition of a corrugated cardboard box.

While reference has been made to configurations wherein the plurality of biodegradable foam panels that form the panel system includes 3, 5, or 6 biodegradable foam panels configured to be folded into a panel sub-assembly and, in some embodiments, connected to one or more other panel sub-assemblies or biodegradable foam panels to form the biodegradable insulating structure, it should be understood that the biodegradable insulating structure of the present disclosure may include more than 6 biodegradable foam panels, such as 7 biodegradable foam panels, 8 biodegradable foam panels, or more, and fewer than 6 biodegradable foam panels, such as 1 biodegradable foam panel, 2 biodegradable foam panels, or 4 biodegradable foam panels, and the decision to recite the present embodiments as having 3, 5, or 6 biodegradable foam panels is only in the interest of convenience and brevity.

In some embodiments, the biodegradable foam panels each have the same thickness. In other embodiments, one or more panels have a first thickness and one or more panels have a second thickness. In some embodiments, each panel in the biodegradable insulating structure has a different thickness. For example, a biodegradable insulating structure having 6 panels may include 1, 2, 3, 4, 5, or 6 different thicknesses between the 6 panels. Panels having a greater thickness improves the structural integrity and/or the thermal energy retention of the biodegradable insulating structure, which can be advantageous in applications where the increased structural integrity and/or thermal energy retention is desired despite the corresponding increase in weight and material used.

In some embodiments, the biodegradable foam panels include structural elements to secure one or more internal walls. For example, the one or more internal walls can separate the biodegradable insulating structure into two or more separate compartments. As used herein, “structural elements” means lips, notches, ledges, grooves, or other physical features that form, align, and/or secure one or more internal walls in the biodegradable insulating structure.

In some embodiments, one or more supplemental biodegradable foam panels may be positioned within the biodegradable insulating structure to add insulation to one or more sides of the biodegradable insulating structure. For example, each of the plurality of biodegradable foam panels defines a single side of the biodegradable insulating structure and has a thickness, and a supplemental biodegradable foam panel having a second thickness may be added to supplement the thickness of a biodegradable foam panel, thereby supplementing the thermal energy retention of the biodegradable insulating structure.

In some embodiments, one or more of the biodegradable foam panels includes one or more break-points. For example, the break-points may permit the biodegradable foam panel to be broken at a specific point into one or more biodegradable foam panel fragments, reducing the size of the biodegradable foam panel in order to facilitate disposal and compost. As used herein, “break-point” means an engineered, machined, or molded feature where the biodegradable foam panel will preferentially break when force is applied. For example, the break-points may in the form of a line or array of indentations.

In some embodiments, the plurality of biodegradable foam panels are molded, such as by any suitable molding processes known for such materials. An example of a suitable molding process includes forming biobased polymer beads from a melt-processable extrudate and feeding the beads into a mold. The beads may then be subjected to a series of cross-steam and purge steps resulting in a single, monolithic molded article.

In some embodiments, the plurality of biodegradable foam panels are machined from a block of biodegradable foam. As used herein, “machined” means shaving, carving, or cutting a block of biodegradable foam to reduce its size and shape to the desired shape. In some embodiments, the block of biodegradable foam is initially formed via a molding process.

In some embodiments, the biodegradable insulating structure is in the form of an insulated shipper that includes no corrugated cardboard. In some embodiments, the biodegradable insulating structure is surrounded by an outer box. For example, the outer box could be corrugated cardboard, and the biodegradable insulating structure lines the inside walls of the outer box creating an internal space. This internal space would thus be surrounded on all sides first by the biodegradable insulating structure, and second by the corrugated cardboard box.

In some embodiments, the biodegradable insulating structure can be composted in an industrial compost facility in about 7 to about 42 days, such as within about 7 to about 21 days.

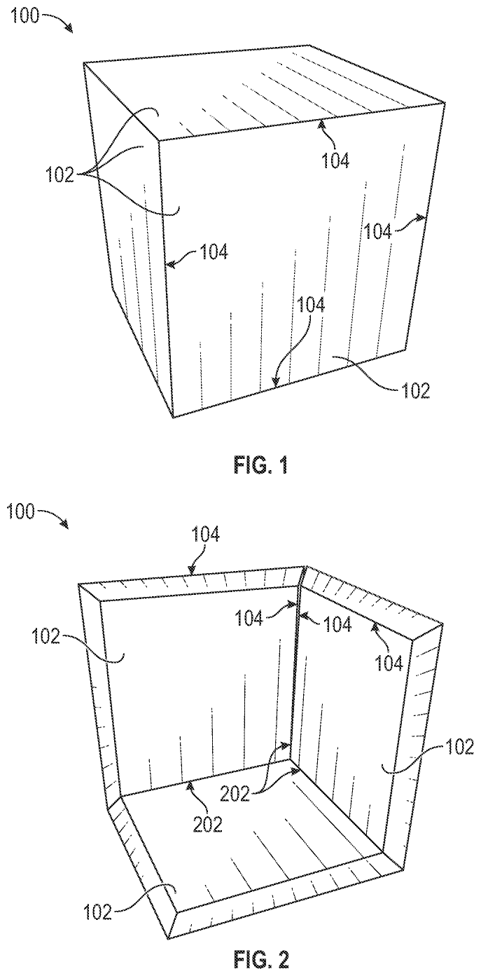

FIG. 1 shows a biodegradable insulating structure 100 including a plurality of biodegradable foam panels 102 having edges 104. In some instances, the biodegradable insulating structure may have six panels forming a container or box. In other instances, the biodegradable insulating structure may have one, two, three, four, five, seven, eight, or more panels. The panels may have a square shape having four edges of equal length, a rectangular shape having two pairs of edges of varying lengths, or another shape having a corresponding number of edges with suitable lengths.

In structures formed from a plurality of panels 102, at least two of the plurality of panels may be disposed next to one another and interface along one of the edges of each of the at least two panels, the interfacing edges forming a seal to retain thermal energy, exclude thermal energy, prevent or reduce thermal energy transfer, or a combination thereof. The length of one edge may or may not be the same length as an adjacent edge so that a seal is formed between interfacing edges. The shape of one edge may correspond to the shape of an adjacent edge so that a seal is formed between interfacing edges. Various configurations of such corresponding edges are described below; however, any suitable mechanical edge connection that achieves the desired thermal seal between interfacing panels may be utilized. The shape of all edges of a panel may be the same, or some edges may have one shape, e.g., beveled, while other edges have another shape, e.g., rectilinear.

FIG. 2 is a perspective view of a biodegradable insulating structure 100 including three biodegradable foam panels 102 having edges 104, such as may be used to form an insulating insert or partial insulating container, or which may be combined with additional panels to form a container, as described herein. Biodegradable foam panels 102 are positioned such that interfacing edges 104 form a seal 202 to retain thermal energy, exclude thermal energy, prevent or reduce thermal energy transfer, or a combination thereof. FIG. 2 depicts the biodegradable insulating structure 100 of FIG. 1 with three panels removed.

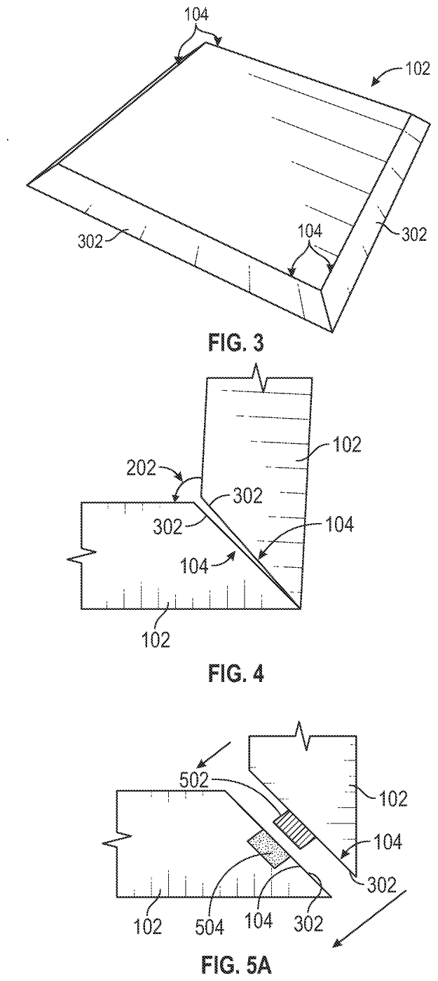

FIG. 3 shows a biodegradable foam panel 102 having edges 104. Edges 104 have a beveled surface 302. FIG. 3 depicts one biodegradable foam panel used in the formation of the biodegradable insulating structure 100 depicted in FIGS. 1-2. In some instances, the edges of the panel are shaped at an angle, such as through beveling, chamfering, scouring, or other process to increase the surface area available for the edges of adjacent panels to interface with each other. Thus, while the thickness of a panel may be one measurement, the process of forming the edge, e.g., beveling, results in a beveled surface of a measurement greater than the thickness of the panel, improving the thermal retention properties without substantially changing the panel dimensions or the dimensions of the biodegradable insulating structure.

While reference has been made to edges being “beveled,” it is to be understood that any suitable shaped edge that permits interfacing panels to form a seal is contemplated. Where reference is made to “beveled” edges, the decision to recite only edges being beveled is merely for convenience and brevity, and any suitable shaped edge may be substituted, combined, added, or changed in place of a beveled edge.

FIG. 4 shows a seal 202 formed by beveled surfaces 302 of interfacing edges 104 of adjacent biodegradable foam panels 102. In some instances, the seal is formed by interfacing the beveled surfaces of two adjacent beveled edges. In other instances, as described herein, rectilinear edges are joined to form the seal.

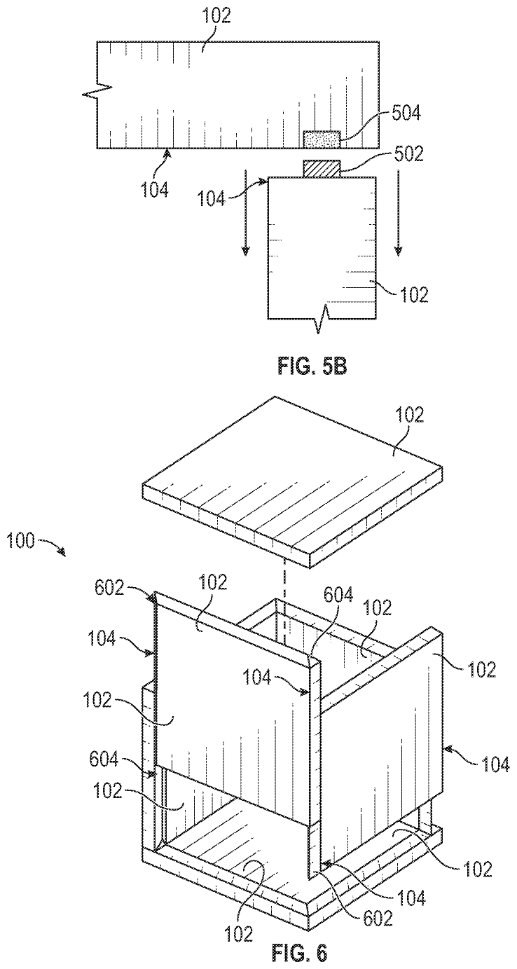

FIG. 5A shows biodegradable foam panels 102 having edges 104 with beveled surfaces 302 in addition to mechanical locking tabs 502 and mechanical locking slots 504. FIG. 5B is a cross-sectional view of biodegradable foam panels 102 having rectilinear edges 104 with mechanical locking tabs 502 and mechanical locking slots 504. In some instances, there may be one set of mechanical locking tabs and slots that run the length of the edge of a panel. In other instances, there are multiple sets of discrete tabs and slots in particular positions along the edge of a panel. The edge of a panel may have a portion with mechanical locking tabs or slots and a portion without tabs or slots. The edge of one panel may have both tabs and slots that correspond to matching slots and tabs on the edge of an adjacent panel. The edges of a panel may vary in shape, with some edges being beveled and others being rectilinear, but both types of edges may have mechanical locking tabs and slots corresponding to mechanical locking slots and tabs of edges of adjacent panels.

FIG. 6 shows a biodegradable insulating structure 100 including a plurality of biodegradable foam panels 102 having edges 104 with V-shaped edges 602 and V-shaped grooves 604. In some instances, the V-shaped edges and grooves facilitate sliding the panels into place such that they interlock. A panel corresponding to a “lid” may be placed on top of a biodegradable insulating structure formed by sliding panels having V-shaped edges and grooves into place against each other. Panels may have a combination of edges with V-shaped edges and/or grooves and other edges with mechanical locking tabs and/or slots. The biodegradable insulating structure may have some panels with V-shaped edges and/or grooves and other panels with mechanical locking tabs and/or slots. Each edge may have a portion with a V-shaped edge or groove and another portion with mechanical locking tabs or slots, and each edge may have a portion with no edge modification.

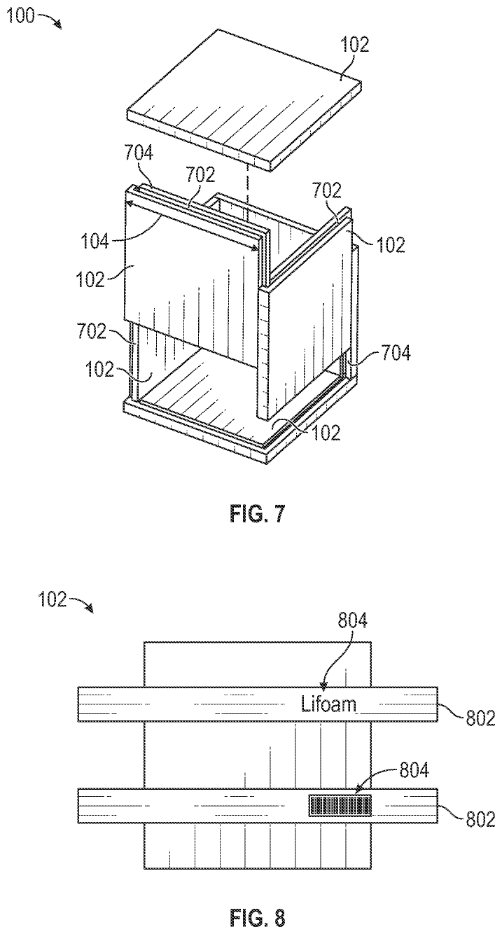

FIG. 7 shows a biodegradable insulating structure 100 including a plurality of biodegradable foam panels 102 having edges 104 with rectilinear tongues 702 and rectilinear grooves 704. In some instances, the rectilinear tongues and grooves facilitate sliding the panels into place such that they interlock. A panel corresponding to a “lid” may be placed on top of a biodegradable insulating structure formed by sliding panels having rectilinear tongues and grooves into place against each other. The biodegradable insulating structure may have some panels with rectilinear tongues and/or grooves, other panels with V-shaped edges and/or grooves, and/or other panels with mechanical locking tabs and/or slots. Panels may have some edges with rectilinear tongues and/or grooves, other edges with V-shaped edges and/or grooves, and/or other edges with mechanical locking tabs and/or slots. Each edge may have a portion with rectilinear tongues and/or grooves, a portion with V-shaped edges and/or grooves, a portion with mechanical locking tabs and/or slots, and/or a portion with no edge modification.

FIG. 8 shows a biodegradable foam panel 102 including a biodegradable tape 802 having identifying marks 804. In some instances, there are two pieces of biodegradable tape on the panel. In other instances, there is one piece of tape, three pieces of tape, or more than three pieces of tape. In some instances, the tape runs the length of the panel with some overhang over the edges of the panel. In other instances, the tape is placed on only the edge of the panel leaving a central portion of the panel with no tape. The tape may be placed perpendicular to the edge of the panel, along the length of the edge of a panel, or at an angle to the perpendicular such that the tape crosses the corner of a panel. The tape may have identifying marks such as logos, tradenames, product names, barcodes, serial numbers, expiration dates, or the like printed on the tape. The identifying marks may be printed, written, engraved, cut into, or otherwise placed on the tape in any suitable manner.

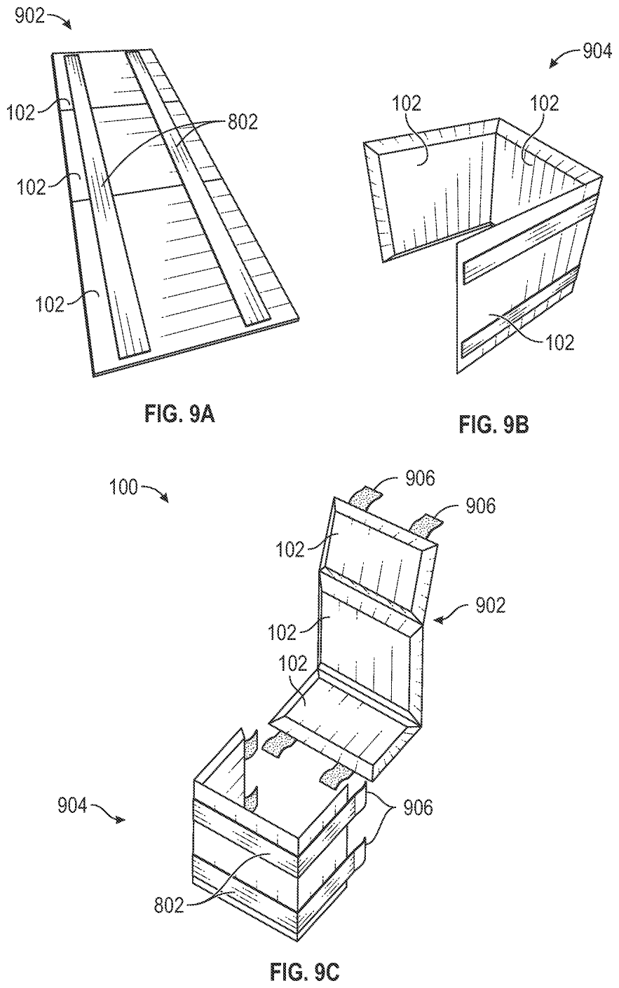

FIG. 9A is a perspective view of a panel system including three biodegradable foam panels 102 connected by a biodegradable tape 802 to form a panel system 902 that is configured to be folded into a C-shaped assembly. FIG. 9B is a perspective view of a panel system 902 that has been folded to form a C-shaped assembly 904. FIG. 9C is a perspective view of two C-shaped assemblies 904 that are configured to be connected together to form a biodegradable insulating structure 100. Excess biodegradable tape may form tabs 906 that can be folded onto an adjacent panel or C-shaped assembly. For example, tabs 906 may be used to help disassemble the biodegradable insulating structure by providing an easily accessible point of leverage or “pull tabs.” Alternatively or in combination with tabs 906, excess tape 802 that extends past the edge of the relevant panel 102 or that is disposed along a panel may be folded over itself to provide a grippable fold to aid a user in opening the insulating structure 100.

In some instances, two C-shaped assemblies are positioned together to form the biodegradable insulating structure. In other instances, one C-shaped assembly constitutes the biodegradable insulating structure, depending on the circumstances. In other instances, one C-shaped assembly is used in conjunction with one or more biodegradable foam panels that may or may not be joined by a flexible connecting means to form the biodegradable insulating structure. For example, one C-shaped assembly may be used in conjunction with two panels joined by tape to form a 5-sided open box. The tape may form tabs that overhang the edges of the panels and the tabs may be used to join the C-shaped assembly with another C-shaped assembly or other panel or panels and/or may be used to open the insulating structure. The edges of the panels may be beveled such that the gap between connected panels in a flat configuration is minimal but the beveled surface permits the panels to fold against each other. The edges of the panels may have edge modifications such as mechanical locking tabs and/or slots, V-shaped edges and/or grooves, and/or rectilinear tongues and/or grooves, and these modifications may facilitate joining a C-shaped assembly with another C-shaped assembly or another panel system, either in addition to or instead of the biodegradable tape.

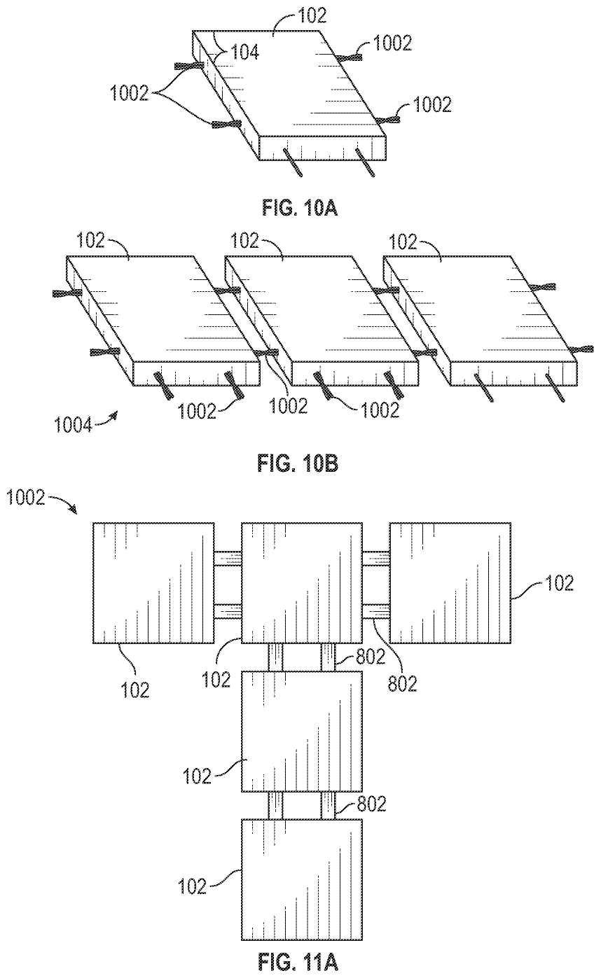

FIG. 10A is a perspective view of a biodegradable foam panel 102 having rectilinear edges 104 and filament 1002 molded within the panel. FIG. 10B is a perspective view of a panel system 1004 formed by three biodegradable foam panels 102 joined by filament 1002 molded within the panels. In some instances, each panel has two lines of filament exiting each edge of the panel. In other instances, there are more or fewer lines of filament exiting the edges of the panel. There may be filament exiting only one edge of the panel, two edges of the panel, three edges of the panel, or some other number of edges of the panel. Panels connected together by the filament may have a gap permitting the panels to fold together. The edges of the panels may be beveled such that the gap between connected panels is minimal in a flat configuration but the beveled surface permits the panels to fold against each other. In embodiments in which the filament 1002 is not molded within the panel, similar filament materials may be provided along the external or internal surfaces of the panels, similar to the tape embodiments described herein. Filament provided along the external or internal surfaces of the panels may be used in combination with biodegradable tape.

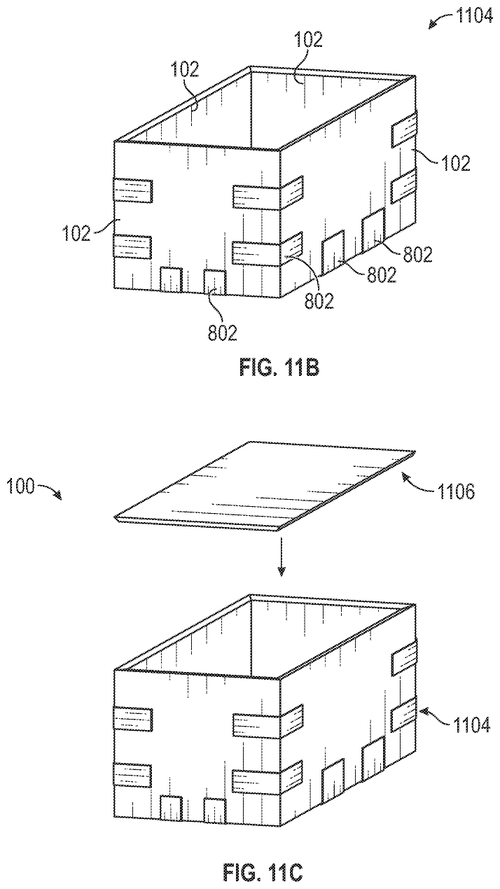

FIG. 11A shows five biodegradable foam panels 102 connected by a biodegradable tape 802 to form a panel system 1102 that is configured to fold into a 5-panel box. FIG. 11B is a perspective view of a panel system 1102 that has been folded to form a 5-panel box 1104. FIG. 11C is a perspective view of a biodegradable foam lid 1106 positioned against a 5-panel box 1104 to form a biodegradable insulating structure 100. In some instances, the five panels may be connected to form a “T”-shaped panel system when positioned in a flat configuration, or blank. In other instances, the five panels may be connected to form a “+”-shaped or cross-shaped panel system when positioned in a flat configuration, or blank. In other instances, the five panels may be connected to form an “S”-shaped panel system Any suitable positioning of the five panels may be used to form the panel system that is configured to be folded into a 5-panel box. The five panels may be joined with biodegradable tape or may be joined with biodegradable filament. The panels may have beveled edges such that the gap between adjacent connected panels is minimal in a flat configuration as previously described, or the panels may have rectilinear edges with a gap permitting the panels to be folded together. The five panels may have a combination of beveled edges and rectilinear edges with varying sized gaps between the panels. The biodegradable foam lid may have beveled edges, rectilinear edges, a combination of beveled edges and rectilinear edges, or any suitable shaped edge.

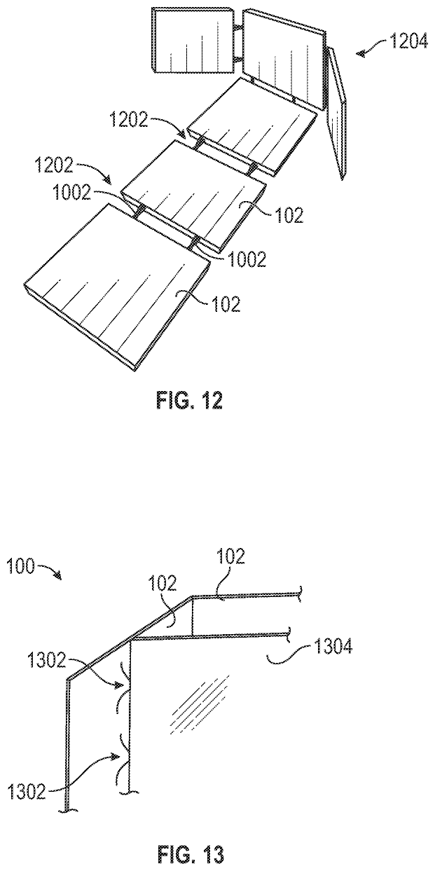

FIG. 12 shows six biodegradable foam panels 102 connected by a biodegradable filament 1002 but separated by gaps 1202 to form a panel system 1204 that is configured to be folded into a 6-panel box. In some instances, the six panels may be connected to form a “T”-shaped panel system when positioned in a flat configuration, or blank. In other instances, the six panels may be connected to form a “+”-shaped or cross-shaped panel system when positioned in a flat configuration, or blank. In other instances, the six panels may be connected to form an “S”-shaped panel system. Any suitable positioning of the six panels may be used to form the panel system that is configured to be folded into a 6-panel box. The panels may have beveled edges such that the gap between adjacent connected panels is minimal as previously described, or the panels may have rectilinear edges with a gap permitting the panels to be folded together. The six panels may have a combination of beveled edges and rectilinear edges with varying sized gaps between the panels. Upon folding, the resulting biodegradable insulating structure may have a “lid” formed by one of the six panels such that the structure may be “opened” by unfolding the panel.

FIG. 13 shows the inside of a biodegradable insulating structure 100 including a plurality of biodegradable foam panels 102. The biodegradable foam panels 102 include structural elements 1302 that align and secure internal walls 1304. The structural elements may be lips, notches, ledges, grooves, or other physical features that form, align, and/or secure one or more internal walls in the biodegradable insulating structure. The structural elements may run the length of the panel, or there may be multiple discrete structural elements. There may be multiple sets of structural elements designed to separate the biodegradable insulating structure into two, three, four, or more separate compartments. The internal wall may be formed out of biodegradable foam, corrugated cardboard, or any other material suitable for dividing the biodegradable insulated structure into multiple compartments. The internal wall may be positioned vertically, horizontally, or in any orientation suitable for dividing the biodegradable insulating structure into multiple compartments. The internal wall may be positioned perpendicular to the panel having structural elements, or it may be positioned at any angle to the perpendicular.

FIG. 14A shows a biodegradable insulating structure 100. FIG. 14B is a perspective view of the biodegradable insulating structure 100 depicted in FIG. 14A with the addition of two supplemental biodegradable foam panels 1402. In some instances, there are two supplemental panels. In other instances, there is one, three, four, five, six, or more than six supplemental panels. The supplemental panels may be positioned vertically alongside vertical portions of the biodegradable insulating structure. The supplemental panels may be positioned horizontally alongside horizontal portions of the biodegradable structure. The supplemental panels may have rectilinear edges or beveled edges. There may be an equivalent number of supplemental panels as there are panels composing the biodegradable insulating structure, resulting in a structure within a structure that supplements the thickness of all sides of the biodegradable insulating structure.

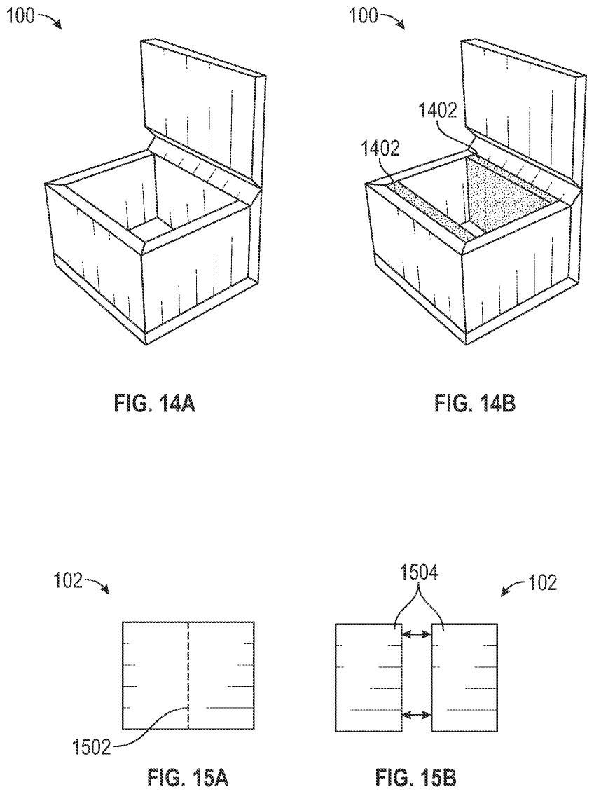

FIG. 15A shows a biodegradable foam panel 102 having break-points 1502. FIG. 15B is a perspective view of biodegradable foam panel 102 after breakage along break-point 1502 producing two biodegradable foam panel fragments 1504. In some instances, there is one break-point. In other instances, there are two, three, four, or more break-points. The break-point may result in two biodegradable foam panel fragments of equal size, or the fragments may have different sizes. The break-point may be designed to result in fragments of a size and shape suitable for composting or other post-consumer processing, or for use as a supplemental biodegradable foam panel as depicted in FIG. 14B. The break-point may be designed to result in fragments of a size and shape suitable for combining with other fragments or biodegradable foam panels to form a biodegradable insulating structure.

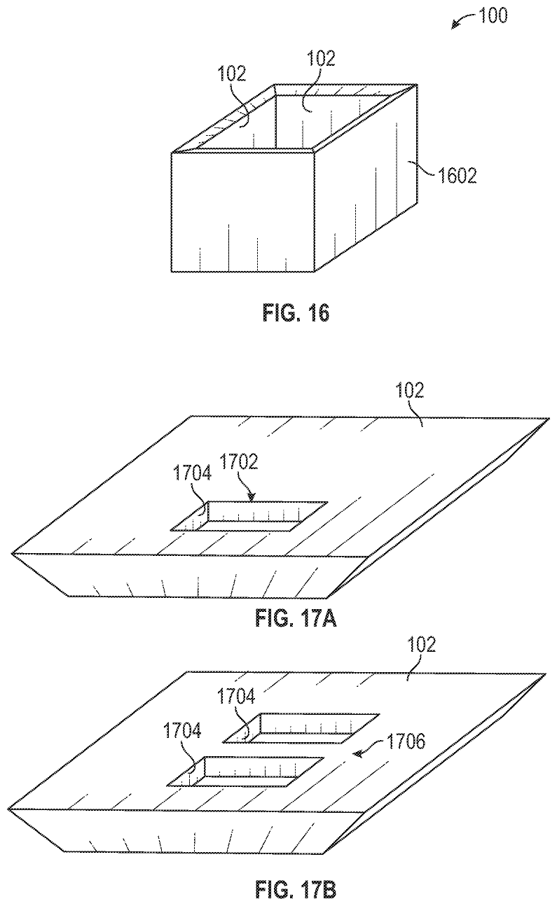

FIG. 16 shows a biodegradable insulating structure 100 including a plurality of biodegradable foam panels 102 surrounded by an outer box 1602. The outer box may be corrugated cardboard or any material suitable as a container. For example, the outer box may provide structural support and mechanical properties suitable for use as a shipping container. The outer box may have a lid that folds to cover the biodegradable insulating structure. The outer box may surround only a portion of the biodegradable insulating structure leaving one or more sides uncovered.

FIG. 17A shows a biodegradable foam panel 102 having a handle 1702. Handle 1702 includes a surface feature 1704, which is designed to provide improved handling of the article. For example, the surface feature 1704 may be any suitable depression or projection that provides a user with a grippable surface with which to carry, open, or otherwise handle the structure or panel 102 containing the feature. The surface features may have any suitable size, geometry, and position in the panel. FIG. 17B is a perspective view of a biodegradable foam panel 102 having a handle 1706 formed out of two surface features 1704, which are in the form of depressed channels molded in a surface of the panel. The handle may be formed through the molding process that forms the biodegradable foam panel, or it may be machined out of the biodegradable foam panel after the panel has been formed. The handle may be configured to be used by a “pick and place” robot as described herein.

The handle may be rectangular in overall shape, or it may have another suitable shape, such as triangular or another shape. The handle may include one impression or surface feature, or it may include more than one impression, such as two impressions. The handle may be positioned on the upward facing panel to act as a handle for opening the biodegradable insulating structure, or the handle may be positioned on the side panels of the biodegradable insulating structure to act as a handle for carrying the biodegradable insulating structure. There may be one handle in the panel, or there may be more than one handle. For example, there may be a handle proximal to each of the sides of the panel so the panel has symmetry and can be positioned in any direction when constructing the biodegradable insulating structure.

In some embodiments, the biodegradable foam panels have a density from about 0.015 g/cm³ to about 0.03 g/cm³. In some embodiments, the biodegradable insulating structure has a weight that is about 50% of a weight of a competitive “green” insulating structure of the same dimensions. In some embodiments, each of the biodegradable foam panels have a flex strength equal to or greater than a flex strength of an expandable polystyrene (EPS) structure of the same dimensions.

Methods of Manufacturing Biodegradable Insulating Structures

Methods of making a biodegradable insulating structure are also disclosed herein. In one aspect, a method includes providing a plurality of rigid biodegradable foam panels formed from biobased polymer foam beads, the biobased polymer foam beads including polylactic acid. In some embodiments, the method further includes assembling the plurality of biodegradable foam panels into a biodegradable insulating structure, wherein at least two of the plurality of biodegradable foam panels are disposed next to one another and interfacing along at least one of the edges of each of the at least two panels, the interfacing edges forming a seal. Any suitable methods and equipment known for forming foam panels may be used to manufacture the panels described herein. For example, methods and equipment known for manufacturing known EPS panels may be used. The panels manufactured by these methods may be the panels described herein, including any combination of features thereof.

For example, U.S. Pat. No. 10,518,444 to Pawloski et al. discloses methods of producing compostable or biobased foams that are useful for fabricating foamed articles. In the described method, foamed beads formed from a biobased polyester and a blowing agent are molded to form a molded article. The method can be adapted to produce the biodegradable foam panels of the present disclosure.

In some embodiments, the plurality of biodegradable foam panels include beveled edges. In certain embodiments, the edges of the biodegradable foam panels are molded or machined to form the desired edge geometry.

In some embodiments, the assembling includes interlocking mechanical locking tabs and corresponding mechanical locking slots disposed about edges of each of the plurality of biodegradable foam panels to facilitate a compression fit interlock between interfacing edges of the panels.

In some embodiments, assembling includes interlocking V-shaped grooves and V-shaped edges disposed about edges of each of the plurality of biodegradable foam panels to facilitate interlocking between interfacing edges of the panels.

In some embodiments, assembling includes interlocking rectilinear tongues and rectilinear grooves disposed about edges of each of the plurality of biodegradable foam panels to facilitate interlocking between interfacing edges of the panels.

In some embodiments, providing a plurality of biodegradable foam panels includes applying a biodegradable tape, gumback, or filament onto the surface of at least one of the biodegradable foam panels. In some embodiments, the biodegradable tape, gumback, or filament is applied manually after the biodegradable foam panels have been formed. In other embodiments, the biodegradable tape, gumback, or filament is applied by an automated arm assembly after the panels are formed. In other embodiments, the biodegradable tape, gumback, or filament is applied by moving the panels over a table equipped with a tape application assembly. In other embodiments, the providing a plurality of biodegradable foam panels includes molding a biodegradable filament within one or more of the plurality of biodegradable foam panels.

In some embodiments, applying the biodegradable tape or filament includes connecting more than one of the panels to each other using the biodegradable tape or filament. In some embodiments, the connected panels are connectively separated by a gap. For example, the assembling is enabled by the gap being of a size that permits each of the biodegradable foam panels to fold against adjacent panels to form the biodegradable insulating structure, with the biodegradable tape or filament holding the biodegradable foam panels in a folded position to form the biodegradable insulating structure.

In some embodiments, applying the biodegradable tape includes printing identifying marks on the biodegradable tape. In other embodiments, applying the biodegradable tape includes applying a biodegradable tape that has been manufactured with identifying marks.

In some embodiments, the plurality of biodegradable foam panels are provided as a 3-panel system configured to form a C-shaped assembly. In some embodiments, the assembling includes folding two of the 3-panel systems each into a C-shaped assembly and securing together the two C-shaped assemblies to form the biodegradable insulating structure.

In some embodiments, the plurality of biodegradable foam panels are provided in a 5-panel system and the assembling includes folding the 5-panel system and securing edges of the panels to form a 5-panel box. In some embodiments, assembling the biodegradable insulating structure includes positioning a biodegradable foam panel lid onto an open side of the 5-panel box.

In some embodiments, the plurality of biodegradable foam panels are provided in a 6-panel system and the assembling includes folding the 6-panel system and securing edges of the panels to form a 6-panel box.

In some embodiments, forming the biodegradable foam panels includes forming one or more panels at a first thickness and forming one or more panels at a second thickness. Forming the panels may include forming each panel to have the same thickness as every other panel in the biodegradable insulating structure, a different thickness as every other panel in the biodegradable insulating structure, or some combination thereof. For example, a biodegradable insulating structure having 6 panels may include forming the panels such that 1, 2, 3, 4, 5, or 6 different panel thicknesses exist between the 6 panels. Forming panels to have a greater thickness improves the structural integrity and/or the thermal energy retention of the biodegradable insulating structure, which can be advantageous in applications where the increased structural integrity and/or thermal energy retention is desired despite the corresponding increase in weight and material used.

In some embodiments, the plurality of biodegradable foam panels include structural elements configured to secure one or more internal walls. In some embodiments, the assembling includes installing one or more internal walls for separating the biodegradable insulating structure into two or more separate compartments.

In some embodiments, forming the biodegradable foam panels includes forming one or more handles on the surface of one or more panels to accommodate gripping the panel. In some embodiments, the handle is formed (e.g., molded or machined) into the surface of the top panel of a biodegradable insulating structure, permitting the panel to be easily opened. In some embodiments, the handle is formed into the surface of one or more side panels of the biodegradable insulating structure, permitting the structure to be easily lifted and moved.

In some embodiments, one or more of the plurality of biodegradable foam panels includes one or more break-points to facilitate breakage of one or more of the biodegradable foam panels into fragments for disposal and compost. For example, the break-points may be formed by scoring, indenting, perforating, or other suitable processes.

In some embodiments, the method includes forming the plurality of biodegradable foam panels by molding and/or machining.

In some embodiments, the assembling includes the use of one or more “pick and place” robots, which are known in the art. For example, the robots may unload the biodegradable foam panels from the mold and position the panels relative to other panels such that they form the biodegradable insulating structure, or such that they can be joined together with biodegradable tape or filament and subsequently folded to form the biodegradable insulating structure, as described herein. The robots may be equipped with suction grippers, needle grippers, or claw grippers configured to sufficiently grip and maneuver the panels. In some embodiments, the needle grippers include four or more needles arranged in two different directions configured to extend and be driven into the panel for maneuvering. In some embodiments, the biodegradable foam panels include molded cavities corresponding to the claw grippers to more easily pick up and position the panels. The robots may be configured to position the panels inside a corrugated cardboard box, or they may be configured to position the panels together to form a biodegradable insulating structure suitable as a shipper without the use of corrugated cardboard.

In some embodiments, the assembling includes inserting one or more supplemental biodegradable foam panels into the biodegradable insulating structure. Adding one or more supplemental biodegradable foam panels may supplement the thermal energy retention, thermal energy exclusion, or prevention or reduction of thermal energy transfer into and/or out of the biodegradable insulating structure.

In some embodiments, the assembling includes surrounding the biodegradable foam panels with an outer box. For example, the plurality of biodegradable foam panels may be surrounded by a corrugated cardboard outer box. In particular, an outer box is useful where the biodegradable insulating structure is composed of fewer biodegradable foam panels than is necessary to form a stand-alone container. For example, a biodegradable insulating structure formed out of three panels may be insufficient to be used as a stand-alone container, so an outer box would surround the biodegradable insulating structure. In some embodiments, the outer box may provide further structural support for the biodegradable insulating structure.

In some embodiments, the biodegradable foam panels have a weight that is about 50% the weight of competitive “green” insulating structures of the same size and dimensions, while maintaining an equal or superior flex strength of the competitive “green” insulating structure. In other words, the biodegradable foam panels have reduced density as compared to competitive “green” insulating structures, but a higher flex strength than expected given the reduced density.

In some embodiments, the biodegradable insulating structure degrades by industrial compost within a time period of about 7 days to about 41 days, such as within about 7 to about 21 days.

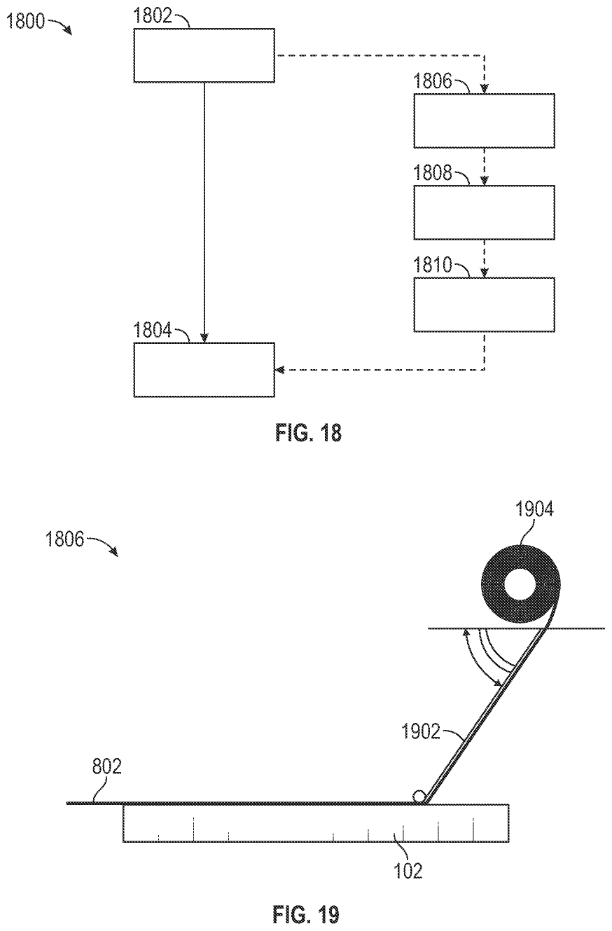

FIG. 18 is a flowchart depicting a method 1800 for making a biodegradable insulating structure. Step 1802 includes forming a plurality of biodegradable foam panels. Step 1804 includes assembling the plurality of biodegradable foam panels. Optional step 1806 includes connecting one or more of the plurality of foam panels with biodegradable tape or filament. Optional step 1808 includes folding the one or more of the plurality of foam panels that are connected by tape or filament. Optional step 1810 includes surrounding the plurality of foam panels with an outer box. In some instances, the method may include steps 1806 and 1808 but omit step 1810. In other instances, the method may include step 1810 but omit steps 1806 and 1808. In other instances, all of steps 1806, 1808, and 1810 are included.

FIG. 19 is an illustration of step 1806, in which biodegradable tape 802 is applied to the surface of biodegradable foam panel 102 by arm assembly 1902. Arm assembly 1902 feeds biodegradable tape 802 from a spool 1904, and presses tape to the surface of the panel 102. In some embodiments, an arm assembly applies one piece of tape of varying length. In other embodiments, an arm assembly applies more than one piece of tape. In other embodiments, there are multiple arm assemblies, each applying one or more pieces of tape to the panels. The assembly may be configured to apply one or more pieces of tape to a single panel. The assembly may be configured to apply a piece of tape to more than one panel such that the panels are joined by the piece of tape. The assembly may be configured to apply a piece of tape to a pair of panels, joining the panels, and subsequently apply a different piece of tape to one of the pair of panels and a third panel, joining all three panels together with the pieces of tape. The arm assembly may be configured to apply tape to the panels upon removal from the mold. The arm assembly may be configured to apply tape in a step isolated from the mold.

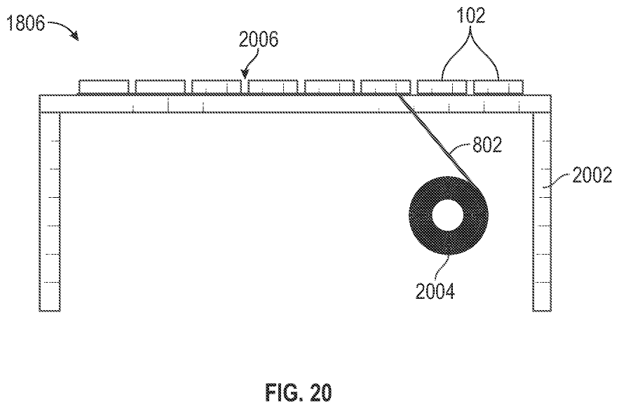

FIG. 20 is an alternate illustration of step 1806, in which biodegradable tape 802 is applied to the surface of biodegradable foam panels 102 by a table 2002 having a spool or reel of tape 2004. The panels pass over the table 2002 and the tape 802 is adhered to the surface of the panels. In some embodiments, multiple panels are passed over the table in succession, with a gap 2006 between adjacent panels, such that the panels are joined together by the tape. The gap 2006 facilitates folding of the panels to form a biodegradable insulating structure, as previously described. In some embodiments, the table applies a piece of tape to a single panel. In other embodiments, the table applies a continuous piece of tape to multiple foam panels. In other embodiments, the table applies a single piece of tape to a pair of panels spanning the gap between the pair, and another piece of tape spanning the next gap between the next pair of panels.

Biodegradable insulating structures, assemblies, and associated methods have been provided. These biodegradable insulating structures are formed out of biodegradable foam panels designed to seal in thermal energy when neighboring edges interface with each other. The panels are formed out of polylactic acid by molding, machining, or other suitable forming process. In some embodiments, the biodegradable insulating structure is composed of enough panels to form a stand-alone container that may be used as, for example, an insulated shipper for shipping thermally sensitive articles, such as perishable food or medicine. In other embodiments, the biodegradable insulating structure may be used in conjunction with an outer box, such as a corrugated cardboard box, to provide improved thermal retention, thermal exclusion, and/or prevention or reduction of thermal energy transfer to or from a container that would otherwise lack such capabilities.

### EXAMPLES

The invention may be further understood with reference to the following non-limiting examples.

### Example 1: Flex Strength Test

Table 1 provides the Flex Strength Test results for a rigid polylactic acid foam panel compared to an expandable polystyrene foam panel. As can be seen, a rigid polylactic acid foam panel has 75% the flex strength of an EPS structure of the same size and dimensions, although the rigid polylactic acid foam panel could have a flex strength that is equal or superior to the flex strength of an EPS panel.

TABLE 1

| | | | Flex Strength |
|---|---|---|---|
| Material | Test Type | Density, g/cm³ | Results, MPa |
| Standard EPS | Flex Strength | 0.02 | 0.25 |
| | 3-point bend test | | |
| Polylactic Acid | Flex Strength | 0.02 | 0.16-0.21* |
| | 3-point bend test | | |

*flex strength of PLA panels dependent on thickness and formula

For example, an 18 inch by 26 inch panel (457.2 mm by 660.4 mm) with a thickness of 1 inch (25.4 mm) and weighing about 151 grams was manufactured according to the methods described herein. The density of the panel was about 0.02 g/cm³.

### Example 2: Thermal Performance Comparison with Starch Foam

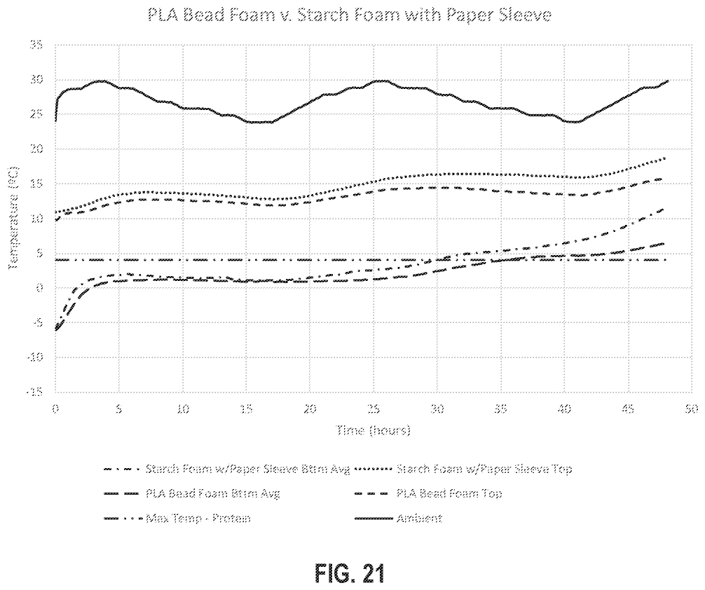

A thermal study was performed to compare the thermal performance for two different biodegradable insulated shippers: one comprising starch foam panels and one comprising PLA foam panels of the present invention. The results are illustrated in FIG. 21.

The thermal study was performed with a payload approximating a typical meal kit. An ISTA (International Safe Transit Association) 7E Heat Temperature Profile was used and is represented by the Ambient Temperature curve. Both the starch foam shipper and the PLA foam shipper were constructed to have a 9 cubic inch internal volume (150 cm³). The PLA foam panels forming the shipper were 1 inch (25 mm) thick and the PLA foam shipper weighed 1.1 pounds (500 g). The starch foam panels were in individual paper sleeves and had a nominal thickness of 1.25 inches (31.8 mm). The starch foam shipper weighed 2.1 pounds (950 g).

The payload was a mock meal kit. Each meal kit included two protein analogues and one non-protein analogue, and the payload for each shipper included two mock meals (four protein analogues and two non-protein analogues) and three 24 oz Propak™ Gel packs at −15° C.±5° C. (available commercially from Lifoam™ Industries LLC, Greer, S.C., USA). The compositions of the protein and non-protein analogues are detailed in Table 2.

TABLE 2

| Protein | 8 oz. Propak ™ |
|---|---|
| Analogue | Gel pack at −20° C. ± 5° C. |
| Non-Protein Analogue | 1 cup Rice |
| (Refrigerated) | 1 × 3.2 oz applesauce squeeze pack |
| | 4 × 2 oz cheese blocks |
| | 2 × Lindt ® Truffles |
| | 1 × 2.40 oz Clif ® Bar |
| | 1 × 1.15 oz nut butter packet |
| | 1 × crumpled plastic lunch bag |
| | 1 × lunch bag |

As illustrated in FIG. 21, the PLA foam shipper maintained a lower temperature than the starch shipper after 50 hours, with the bottom of the PLA foam shipper having a temperature approximately 5° C. lower than the bottom of the starch shipper and the top of the PLA foam shipper having a temperature approximately 3° C. lower than the top of the starch shipper. This performance is significant in view of the PLA shipper having thinner panels (1 inch (25.4 mm) versus 1.25 inches (31.75 mm) for the starch foam panels) and nearly half the weight (1.1 pounds versus 2.1 pounds for the starch foam shipper (500 grams versus 950 grams)). Thus, the use of PLA foam improves thermal performance without significantly affecting flex strength and uses less material, reducing the cost of shipping.

### Example 3: Thermal Performance Comparison of Taped vs Untaped PLA Foam Panels

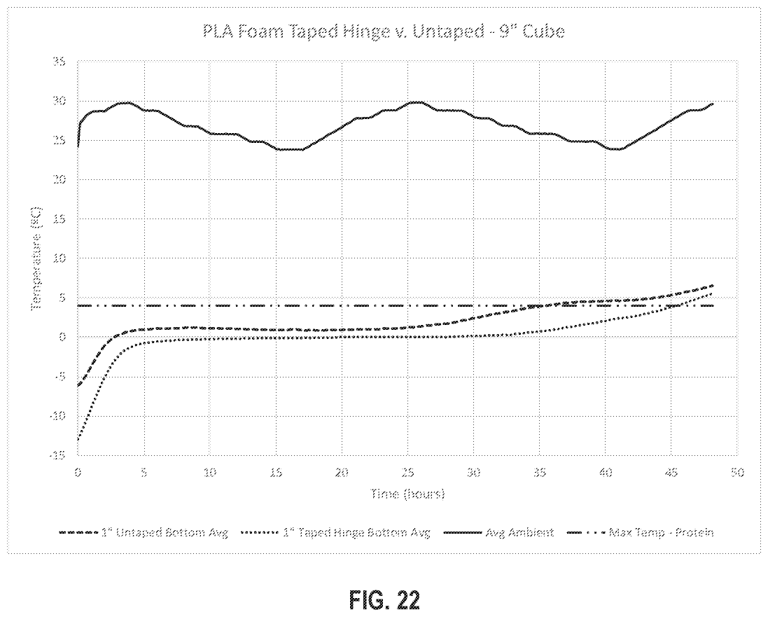

The thermal performance test in Example 2 was repeated for two biodegradable insulated shippers: one comprising PLA foam panels without tape and one comprising PLA foam panels having a taped bottom as described herein and as illustrated in FIG. 9A. The results are illustrated in FIG. 22. In other words, one PLA foam shipper included a PLA foam panel bottom that was prevented from separating from adjacent panels.

As illustrated in FIG. 22, the PLA foam shipper with a taped bottom had better thermal performance. The PLA foam shipper with taped bottom maintained a temperature of approximately 0° C. for approximately 30 hours, while the PLA foam shipper without tape maintained a temperature of only 1-2° C., which temperature began to increase after only 25 hours. With an assumed maximum allowable protein temperature of 4° C., the un-taped PLA foam shipper passed this threshold at approximately 35 hours, while the taped PLA foam shipper maintained a temperature below 4° C. for approximately 45 hours. Thus, the use of tape improves the thermal performance of the PLA shipper by increasing the length of time the contents are kept at lower temperatures.

While the disclosure has been described with reference to a number of embodiments, it will be understood by those skilled in the art that the disclosure is not limited to such disclosed embodiments. Rather, the disclosure can be modified to incorporate any number of variations, alterations, substitutions, or equivalent arrangements not described herein, but which are commensurate with the spirit and scope of the disclosure. Conditional language used herein, such as “can,” “could,” “might,” or “may,” unless specifically stated otherwise, or otherwise understood within the context as used, generally is intended to convey that certain embodiments include, while other embodiments do not include, certain features, elements or functional capabilities. Additionally, while various embodiments of the disclosure have been described, it is to be understood that aspects of the disclosure may include only some of the described embodiments. Accordingly, the disclosure is not to be seen as limited by the foregoing description, but is only limited by the scope of the appended claims.

What is claimed is:

1. A biodegradable insulating structure, comprising:
a plurality of biodegradable foam panels having edges, each of the plurality of biodegradable foam panels being formed of biobased polymer foam beads comprising polylactic acid,
wherein at least two of the plurality of biodegradable foam panels are disposed next to one another and interfacing alone of the edges of each of the at least two panels, the interfacing edges forming a seal.

2. The biodegradable insulating structure of claim 1, wherein the interfacing edges of the at least two biodegradable foam panels are beveled.

3. The biodegradable insulating structure of claim 1, wherein the interfacing edges of the at least two biodegradable foam panels comprise interlocking mechanical locking tabs and mechanical locking slots, interlocking V-shaped grooves and V-shaped edges, interlocking rectilinear tongues and rectilinear grooves, or a combination thereof.

4. The biodegradable insulating structure of claim 1, further comprising a biodegradable film, tape, or filament affixing together two or more of the plurality of biodegradable foam panels.

5. The biodegradable insulating structure of claim 1, wherein the plurality of biodegradable foam panels further comprise structural elements to accommodate one or more internal walls for separating the biodegradable insulating structure into two or more separate compartments.

6. The biodegradable insulating structure of claim 1, wherein the biodegradable insulating structure further comprises one or more supplemental biodegradable foam panels for supplementing a thickness of a biodegradable foam panel.

7. The biodegradable insulating structure of claim 1, wherein at least one biodegradable foam panel in the plurality of biodegradable foam panels has a first thickness, and at least one biodegradable foam panel of the plurality of biodegradable foam panels has a second thickness greater than the first thickness.

8. The biodegradable insulating structure of claim 1, wherein at least one of the plurality of biodegradable foam panels further comprises one or more break-points to facilitate breakage for disposal.

9. The biodegradable insulating structure of claim 1, which is in the form of an insulated shipper and includes no corrugated cardboard.

10. The biodegradable insulating structure of claim 1, further comprising an outer box surrounding the plurality of biodegradable foam panels.

11. The biodegradable insulating structure of claim 1, wherein the biodegradable insulating structure degrades by industrial compost within a time period of about 42 days.

12. A panel system for forming a biodegradable insulating structure, the system comprising:
a plurality of biodegradable foam panels formed of biobased polymer foam beads comprising polylactic acid, each of said panels being connected to at least one other of said panels by flexible connecting means and the plurality of biodegradable foam panels are disposed in a flat configuration,
wherein, in the flat configuration, adjacent biodegradable foam panels are connectively separated by a gap which facilitates the system to be folded at the flexible connecting means, and
wherein, when the system is folded at the flexible connecting means, edges of at least two of the plurality of biodegradable foam panels are configured to interface and form a seal at the interfacing edges.

13. The panel system of claim 12, wherein the flexible connecting means comprises a biodegradable film, tape, or filament.

14. A method of making a biodegradable insulating structure, comprising:
providing a plurality of biodegradable foam panels formed from biobased polymer foam beads comprising polylactic acid, each of the plurality of biodegradable foam panels being rigid; and
assembling the plurality of biodegradable foam panels into a biodegradable insulating structure, wherein at least two of the plurality of biodegradable foam panels are disposed next to one another and interfacing along at least one of the edges of each of the at least two panels, the interfacing edges forming a seal.

15. The method of claim 14, wherein plurality of biodegradable foam panels comprise beveled edges.

16. The method of claim 14, wherein the assembling comprises interlocking mechanical locking tabs and corresponding mechanical locking slots, interlocking V-shaped grooves and corresponding V-shaped edges, interlocking rectilinear grooves and corresponding rectilinear edges, or a combination thereof, disposed about the edges of each of the plurality of biodegradable foam panels.

17. The method of claim 14, wherein the providing the plurality of biodegradable foam panels comprises applying a biodegradable tape onto a surface of at least one of the plurality of biodegradable foam panels in-line with a step of forming the plurality of biodegradable foam panels.

18. The method of claim 17, wherein the biodegradable tape is applied to at least two panels in the plurality of biodegradable foam panels to form a foldable sub-assembly that is configured to be combined with one or more biodegradable foam panels and/or panel sub-assemblies to form the biodegradable insulating structure.

19. The method of claim 14, wherein the plurality of biodegradable foam panels comprise structural elements configured to secure one or more internal walls, and wherein the assembling further comprises installing one or more internal walls for separating the biodegradable insulating structure into two or more separate compartments.

20. The method of claim 14, wherein the assembling further comprises inserting one or more supplemental biodegradable foam panels.

21. The method of claim 14, wherein one or more of the plurality of biodegradable foam panels comprise one or more break-points to facilitate breakage of one or more of the biodegradable foam panels into fragments for disposal or compost.

22. The method of claim 14, further comprising forming the plurality of biodegradable foam panels by molding and/or machining.

23. The method of claim 14, wherein the assembling comprises using one or more robots.
